(19) United States
(12) Patent Application Publication
(10) Pub. No.: US 2011/0075146 A1
(43) Pub. Date: Mar. 31, 2011

(54) COLOR MEASUREMENT DEVICE

(76) Inventors: Nathan Moroney, Palo Alto, CA (US); Jeffrey M. DiCarlo, Menlo Park, CA (US); Steven W. Trovinger, Los Altos, CA (US); Melanie M. Gottwals, San Jose, CA (US); Glen E. Montgomery, San Jose, CA (US); Carl E. Picciotto, Menlo Park, CA (US); Miheer Bhachech, Palo Alto, CA (US)

(21) Appl. No.: 12/569,226

(22) Filed: Sep. 29, 2009

(51) Int. Cl. G01J 3/46

(52) U.S. Cl. 356/402

(57) ABSTRACT

A device includes a housing; a color sensor within a first end of the housing, the color sensor configured to sense a color of a sample when the color sensor is placed proximate the sample; and a display within the housing, the display configured to display the color of the sample sensed by the color sensor.

### BACKGROUND

Typical color measurement devices are relatively large and expensive. For digital imaging and printing applications, typical color measurement devices are designed for knowledgeable color scientists and are usually focused on measuring color devices and profile creation. The typical color measurement devices lack the price-point and ease-of-use properties that would give them wide appeal among graphic artists, interior designers, photographers, and other color designers. In addition, typical color measurement devices are usually not portable. Rather, they are tethered to another device such as a computer for input/output (I/O) and power and are therefore difficult to use in the field. For these and other reasons, a need exists for the present invention.

### BRIEF DESCRIPTION OF THE DRAWINGS

FIG. 1 is a block diagram illustrating one embodiment of a color measurement device system.

FIG. 2 is a block diagram illustrating one embodiment of a color measurement device.

FIG. 3 is a diagram illustrating another embodiment of the color measurement device.

FIG. 4 is a diagram illustrating another embodiment of the color measurement device.

FIG. 5 is a diagram illustrating another embodiment of the color measurement device.

FIG. 6 is a diagram illustrating another embodiment of the color measurement device.

### DETAILED DESCRIPTION

In the following detailed description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

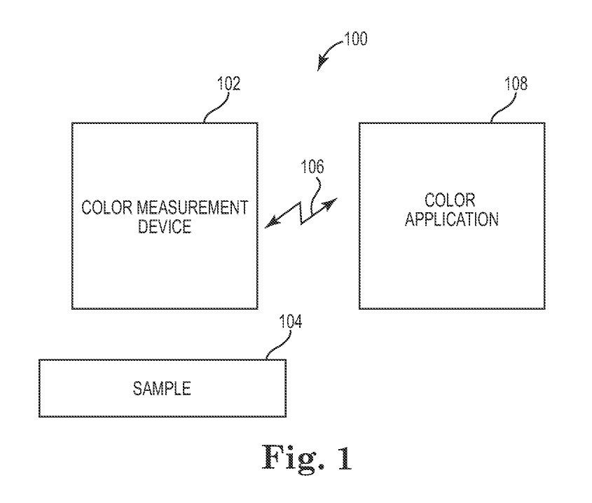

FIG. 1 is a block diagram illustrating one embodiment of a color measurement device system 100. Color measurement device system 100 includes a color measurement device 102 and a color application 108. In one embodiment, color measurement device 102 provides a low cost, compact, wireless color measurement device for measuring the color of a sample 104. In one embodiment, color measurement device 102 processes the color data obtained from measuring the color of a sample 104 and wirelessly transmits the processed color data to a color application 108 through wireless communication link 106. In another embodiment, wireless communication link 106 is replaced with a wired communication link for transmitting the processed color data to a color application 108.

Color application 108 includes any suitable application that uses color data, such as a photography application, a graphics application, a catalog application, etc. Color application 108 is executed on any suitable computing device capable of wirelessly receiving the processed color data from color measurement device 102, such as a computer, a smartphone, etc. In one embodiment, wireless communication link 106 includes a Bluetooth communication link, a wireless local area network (LAN) communication link, an infrared communication link, or another suitable wireless communication link.

In operation, color measurement device 102 senses the color of a sample 104 to provide sensed color data. Sample 104 includes any suitable material, such as a color sample, a paint chip, a fabric, a wood, a metal, a photograph, a person's skin or hair, or any other suitable object. The sensed color data is processed by color measurement device 102 to convert the sensed color data into processed color data that can be used by a color application 108. The processed color data is then transmitted to a color application 108 by color measurement device 102 through wireless communication link 106.

Color measurement device 102 can be used in a wide variety of applications for custom color matching, automatic color palettes, product color coordination, color consulting, or other suitable applications. For example, color designers could use color measurement device 102 to communicate and match colors during the design and production process. Graphic artists could use color measurement device 102 to import colors from the physical world into a computer application. Interior designers could use color measurement device 102 to produce color palettes that work well with a particular piece. Product photographers could use color measurement device 102 to adjust colors in their images so that the product color is correct. Other professionals could also use color measurement device 102 for matching colors and producing color palettes or complement colors from a measured color. Retailers could use color measurement device 102 for suggesting apparel that complements a customer's favorite shirt or tie, for measuring a customer's skin or hair color to suggest appropriate makeup or hair coloring, or to help a color-blind person match their shirt to their pants. A person could also use color measurement device 102 to measure colors at home for producing color-matched paint. Many other applications are also possible.

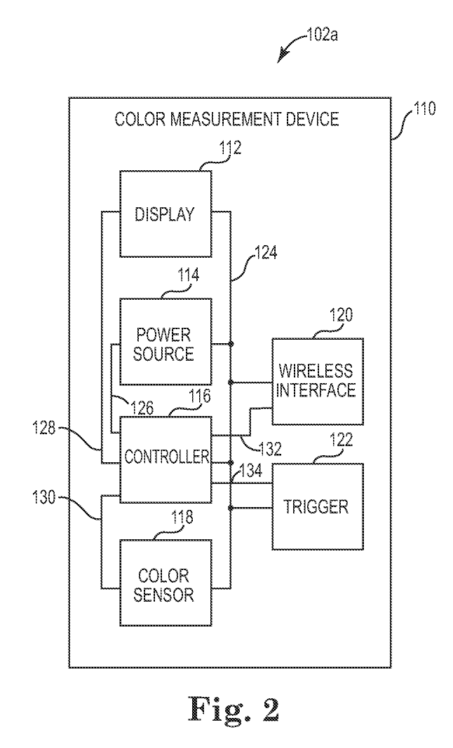

FIG. 2 is a block diagram illustrating one embodiment of a color measurement device 102a. In one embodiment, color measurement device 102a provides color measurement device 102 previously described and illustrated with reference to FIG. 1. Color measurement device 102a includes a housing 110. Within and/or incorporated into housing 110, color measurement device 102 includes a display 112, a power source 114, a controller 116, a color sensor 118, a wireless interface 120, and a trigger 122.

In one embodiment, housing 110 is an elongated, cylindrically-shaped housing, such as a pen-shaped housing. In another embodiment, housing 110 is mouse or puck-shaped. In other embodiments, other suitable shapes are used for housing 110 such that color measurement device 102a is compact, portable, and easily manipulated by a hand of a user.

Power source 114 is electrically coupled to display 112, controller 116, color sensor 118, wireless interface 120, and trigger 122 through power lines 124. Power source 114 provides power to display 112, controller 116, color sensor 118, wireless interface 120, and trigger 122 through power lines 124. In one embodiment, power source 114 includes a battery power source and/or another suitable power source, such as a solar or photovoltaic cell.

Controller 116 is communicatively coupled to display 112 through communication link 128, to power source 114 through communication link 126, to color sensor 118 through communication link 130, to wireless interface 120 through communication link 132, and to trigger 122 through communication link 134. Controller 116 includes a microprocessor, microcontroller, central processing unit (CPU), or another suitable logic device. In one embodiment, controller 116 includes a memory storing firmware and/or software, which is executed by a processor of controller 116 to control the operation of color measurement device 102a. Controller 116 controls and/or monitors the operation of display 112, power source 114, color sensor 118, wireless interface 120, and trigger 122 by receiving signals from and/or by transmitting signals to display 112, power source 114, color sensor 118, wireless interface 120, and trigger 122. In one embodiment, controller 116 receives a signal from power source 114 through communication link 126 indicating the amount of charge remaining before power source 114 is depleted.

Color sensor 118 senses the color of a sample 104. In one embodiment, color sensor 118 includes a colorimeter, a red-green-blue (RGB) color sensor, a hue-saturation-brightness (HSB) color sensor, a cyan-magenta-yellow (CMY) color sensor, or another suitable color sensor. In one embodiment, color sensor 118 includes a height and/or distance detecting ability. In one embodiment, color sensor 118 is self calibrating. Controller 116 activates and deactivates color sensor 118 through communication link 130. Color sensor 118 passes sensed color data to controller 116 through communication link 130. Controller 116 then processes the sensed color data to provide processed color data for a color application 108. For example, in one embodiment, an image of a sample is obtained with a digital camera. Color sensor 118 senses the color of the sample. Controller 116 converts the sensed color data to a color encoding scheme used by the digital camera. In this way, the image of the sample can be adjusted such that the color of the sample is rendered correctly in the image.

Trigger 122 senses a user action for initiating the color sensing of a sample 104 by color sensor 118. In one embodiment, trigger 122 is a pushbutton that is pressed to initiate the color sensing of a sample 104. In another embodiment, trigger 122 is a slide switch that is switched to initiate the color sensing of a sample 104. In another embodiment, trigger 122 is a force feedback tip incorporated into housing 110 that initiates color sensing when the tip is placed on a sample 104. In another embodiment, trigger 122 is a pulse provided by a device external to color measurement device 102a. In another embodiment, trigger 122 is a voice command that initiates color sensing of a sample 104. In other embodiments, other suitable triggers are used. In response to being activated, trigger 122 passes a trigger signal to controller 116. In response to the trigger signal, controller 116 activates color sensor 118 to obtain a color measurement.

Display 112 indicates the color sensed by color sensor 118. In one embodiment, display 112 includes a tricolor RGB light emitting diode (LED) display that provides a color display approximating the color sensed by color sensor 118. In another embodiment, display 112 includes an LCD display. In other embodiments, display 112 provides another suitable indicator for indicating the color sensed by color sensor 118. In one embodiment, display 112 is excluded from color measurement device 102a and is provided by a device external to color measurement device 102a. In response to receiving sensed color data from color sensor 118, controller 116 provides a signal to display 112 through communication link 128 to activate display 112 to display the sensed color. In one embodiment, after a preset time or in response to trigger 122 being deactivated, controller 116 deactivates display 112.

Wireless interface 120 transmits and/or receives data from a color application 108 and/or another suitable device. Wireless interface 120 includes a Bluetooth interface, a LAN interface, an infrared interface, or another suitable wireless interface. Wireless interface 120 receives processed color data from controller 116 through communication link 132. Wireless interface 120 then wirelessly transmits the processed color data to a color application 108 or another suitable device. In one embodiment, wireless interface 120 wirelessly receives configuration data from a color application 108 or another suitable device for configuring color measurement device 102a. In one embodiment, the configuration data includes information for processing the color data obtained by color sensor 118 and/or other suitable information for configuring color measurement device 102a. Wireless interface 120 passes the received configuration data to controller 116 through communication link 132. In another embodiment, wireless interface 120 is replaced with a wired interface for transmitting and/or receiving data.

In operation, to obtain a color measurement, a user places color measurement device 102a proximate a sample 104. The user activates trigger 122 to initiate the sensing of a sample 104 by color sensor 118. Color sensor 118 senses the color of a sample 104 and passes the sensed color data to controller 116. Controller 116 processes the sensed color data to provide processed color data to wireless interface 120 and to control display 112. Display 112 indicates the sensed color to the user. By viewing display 112, the user receives feedback that the color measurement was successful. Wireless interface 120 transmits the processed color data to a color application 108 or another suitable device. The process is repeated to take another color measurement.

In one embodiment, a user can move color measurement device 102a over a sample 104 to take multiple color measurements in response to activating trigger 122. In one embodiment, the multiple color measurements are transmitted to a color application 108 by wireless interface 120. In another embodiment, controller 116 processes the multiple color measurements to generate an average color value, a range of color values, or other suitable data based on the multiple color measurements. The average color value, the range of color values, or the other suitable data based on the multiple color measurements is then transmitted to a color application 108 by wireless interface 120.

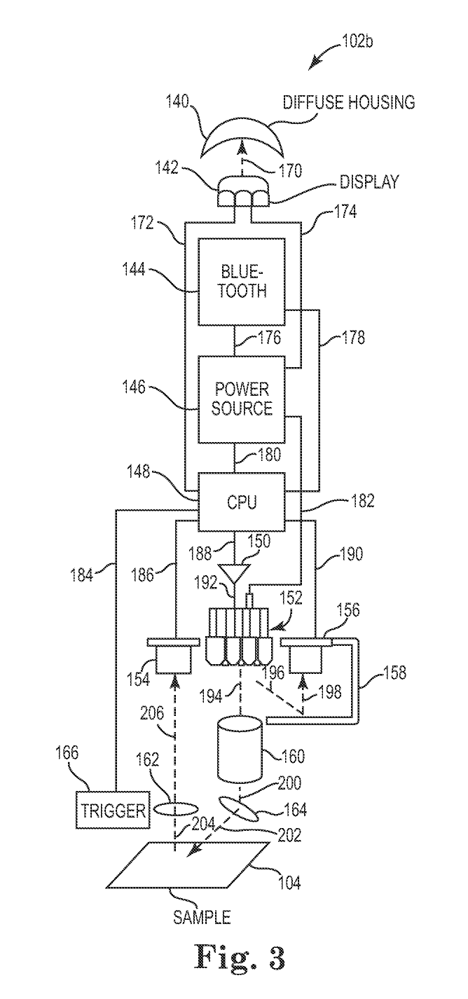

FIG. 3 is a diagram illustrating another embodiment of a color measurement device 102b. In one embodiment, color measurement device 102b provides color measurement device 102 previously described and illustrated with reference to FIG. 1. Color measurement device 102b includes a diffuse housing portion 140, an LED color display 142, a Bluetooth transceiver 144, a power source 146, a CPU 148, a digital-to-analog converter (DAC) 150, LEDs 152, a diffuse sensor 154, a calibration sensor 156, a pocket 158, a tube 160, lenses 162 and 164, and a trigger 166.

Power source 146 is electrically coupled to LED color display 142 through power line 174, to Bluetooth transceiver 146 through power line 176, to CPU 148 through power line 180, and to LEDs 152 through power line 182. In other embodiments, power source 146 is also electrically coupled to trigger 166, DAC 150, diffuse sensor 154, and calibration sensor 156. Power source 146 provides power to LED color display 142, Bluetooth transceiver 144, CPU 148, and LEDs 152. In one embodiment, power source 146 includes a battery power source or another suitable power source, such as a solar cell or photovoltaic cell.

CPU 148 is communicatively coupled to LED color display 142 through communication link 172, to Bluetooth transceiver 144 through communication link 178, to trigger 166 through communication link 184, to diffuse sensor 154 through communication link 186, to DAC 150 through communication link 188, and to calibration sensor 156 through communication link 190. CPU 148 controls and/or monitors the operation of LED color display 142, Bluetooth transceiver 144, trigger 166, diffuse sensor 154, and calibration sensor 156, and DAC 150 by receiving signals from and/or by transmitting signals to LED color display 142, Bluetooth transceiver 144, trigger 166, diffuse sensor 154, calibration sensor 156, and DAC 150.

DAC 150, LEDs 152, diffuse sensor 154, calibration sensor 156, pocket 158, tube 160, and lenses 162 and 164 provide a colorimeter, such as color sensor 118 previously described and illustrated with reference to FIG. 2. DAC 150 converts digital signals from CPU 148 to analog signals for controlling LEDs 152, which are selected to emit light at different peak wavelengths across the visible spectrum (e.g., 450 mm, 470 mm, 520 mm, 560 mm, 610 mm, and 650 mm) for color sensing. The analog signals enable or disable each LED 152 in sequence for sensing the color of a sample 104. LEDs 152 emit light to tube 160 through light path 194 and to pocket 158 through light path 196.

Pocket 158 reflects the light from LEDs 152 to provide the light to calibration sensor 156 through light path 198. Calibration sensor 156 senses the light and passes signals based on the sensed light to CPU 148 through communication link 190. CPU 148 processes the received signals from calibration sensor 156 for measuring any changes in the LED intensities. Based on the measurements, CPU 148 corrects for any LED intensity drift of LEDs 152.

Tube 160 passes the light from LEDs 152 to lens 164 through light path 200. Lens 164 focuses the light from tube 160 onto sample 104 through light path 202. Sample 104 reflects the light focused by lens 164 based on the color of sample 104 to lens 162 through light path 204. Lens 162 focuses the reflected light onto diffuse sensor 154 through light path 206. Diffuse sensor 154 senses the reflected light and passes signals based on the sensed light to CPU 148 through communication link 186. CPU 148 then processes the received signals from diffuse sensor 154 to determine a color measurement for sample 104. In one embodiment, the color measurements are XYZ values, LAB values, spectral reflectance functions, or other suitable values.

Trigger 166 senses a user action for initiating the color sensing of a sample 104 by color measurement device 102b. In one embodiment, trigger 166 is similar to trigger 122 previously described and illustrated with reference to FIG. 2.

LED color display 142 provides an indication of the sensed color measurement. LED color display 142 provides colored light to diffuse housing portion 140 through light path 170. In one embodiment, LED color display 142 includes a red, green, and blue LED that provides a color display approximating the sensed color measurement. In response to determining a color measurement of sample 104, CPU 148 provides a signal to LED color display 142 through communication link 172 to activate LED color display 142 to display the sensed color. In one embodiment, after a preset time or in response to deactivating trigger 166, CPU 148 deactivates LED color display 142.

Bluetooth transceiver 144 transmits and/or receives data from a color application 108 and/or another suitable device. Bluetooth transceiver 144 receives processed color data from CPU 148 through communication link 178. Bluetooth transceiver 144 then wirelessly transmits the processed color data to a color application or another suitable device. In one embodiment, Bluetooth transceiver 144 wirelessly receives configuration data from a color application 108 or another suitable device for configuring color measurement device 102b. In one embodiment, the configuration data includes information for processing the color data and/or other suitable information for configuring color measurement device 102b. Bluetooth transceiver 144 passes the received configuration data to CPU 148 through communication link 178.

In operation, to obtain a color measurement, a user places color measurement device 102b on a sample 104. The user activates trigger 166 to initiate LEDs 152 in sequence for sensing the color of sample 104. Diffuse sensor 154 senses the light reflected by sample 104 and passes signals indicating the sensed light to CPU 148. Calibration sensor 156 senses the light reflected by pocket 158 and passes signals indicating the sensed light to CPU 148. CPU 148 processes the received signals to provide a color measurement of sample 104. CPU 148 passes the color measurement to Bluetooth transceiver 144 and passes a signal based on the color measurement to LED color display 142. LED color display 142 indicates the sensed color to the user. By viewing LED color display 142, the user receives feedback that the color measurement was successful. Bluetooth transceiver 144 transmits the color measurement data to a color application 108 or another suitable device. The process is repeated to take another color measurement. In another embodiment, a user can move color measurement device 102b over a sample 104 to take multiple color measurements in response to activating trigger 166 as previously described with reference to FIG. 2.

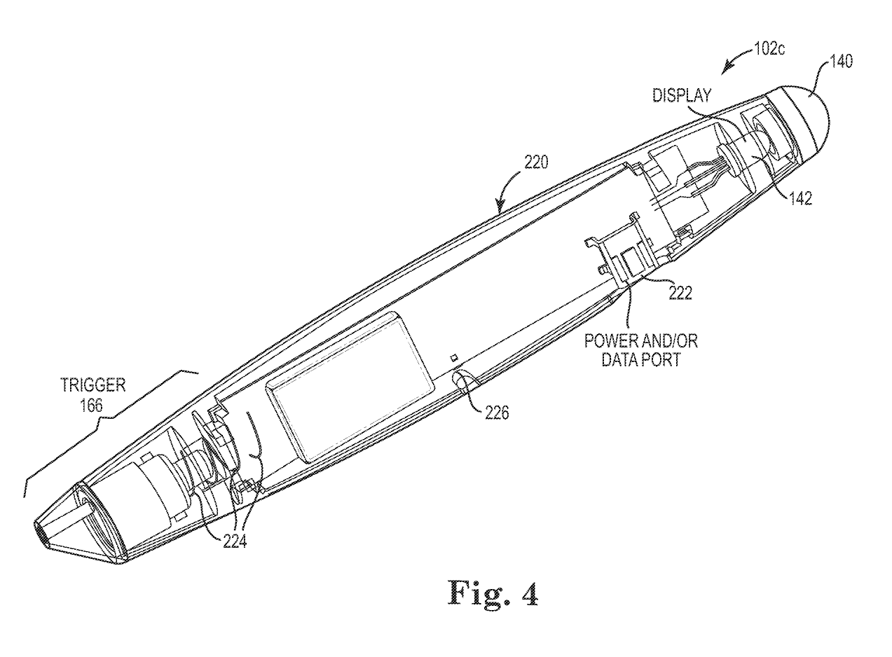

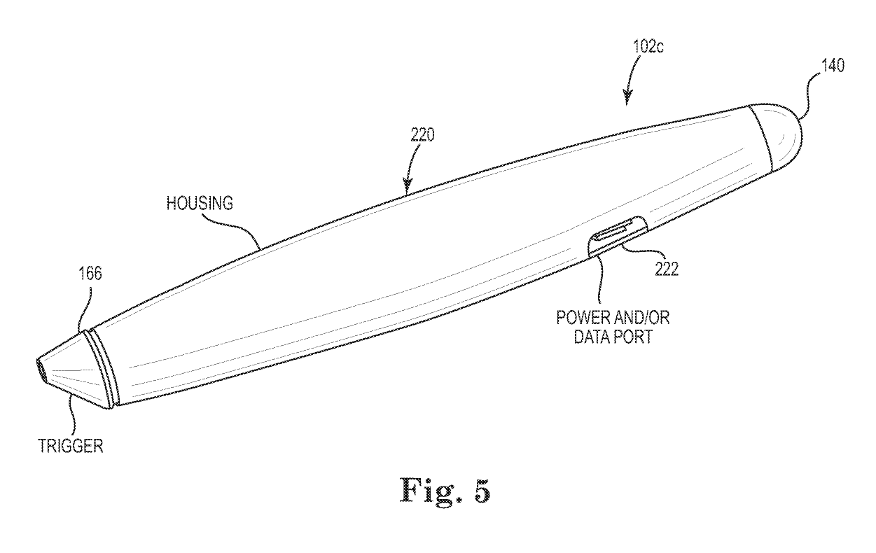

FIGS. 4 and 5 are diagrams illustrating another embodiment of a color measurement device 102c. In one embodiment, color measurement device 102c provides color measurement device 102 previously described and illustrated with reference to FIG. 1. Color measurement device 102c includes an elongated pen-shaped housing 220. Housing 220 is fabricated from metal, plastic, or another suitable material. In one embodiment, the diameter of housing 220 is larger toward the center of the housing and smaller towards the ends of the housing. One end of housing 220 includes a force feedback tip 166 trigger for activating color measurement device 102c when the tip contacts a sample 104. In one embodiment, the exposed portion of force feedback tip 166 is cone shaped. In one embodiment, force feedback tip 166 includes a spring 224 for providing the force feedback.

The other end of housing 220 opposite force feedback tip 166 includes diffuse housing portion 140 for LED color display 142. In one embodiment, diffuse housing portion 140 is dome shaped. In one embodiment, LED color display 142, a Bluetooth transceiver 144, a power source 146, a CPU 148, a DAC 150, a diffuse sensor 154, LEDs 152, a calibration sensor 156, a pocket 158, a tube 160, and lenses 162 and 164 as previously described and illustrated with reference to FIG. 3 are all contained within housing 220. A reset switch 226 is accessible through an opening in housing 220 for resetting color measurement device 102c.

In one embodiment, a power and/or data port 222 extends through housing 220 for connecting a power/and or data cable. Power and/or data port 222 is used for recharging the battery within housing 220 and/or for passing data between color measurement device 102c and another device. In one embodiment, port 222 is a universal serial bus (USB) port.

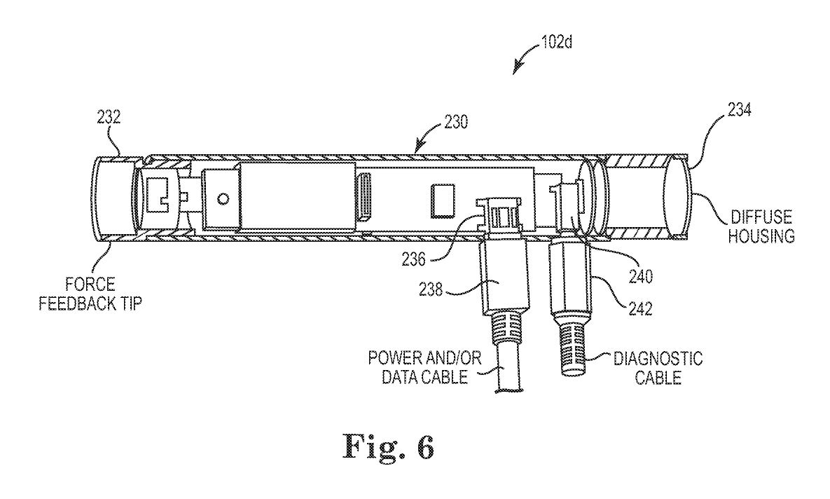

FIG. 6 is a diagram illustrating another embodiment of a color measurement device 102d. In one embodiment, color measurement device 102d provides color measurement device 102 previously described and illustrated with reference to FIG. 1. Color measurement device 102d includes a cylindrical housing 230. One end of housing 230 includes a force feedback tip 232 for activating color measurement device 102d when the tip contacts a sample 104. The other end of housing 230 opposite force feedback tip 166 includes diffuse housing portion 234 for an LED color display. In this embodiment, force feedback tip 232 and diffuse housing portion 234 are cylindrical in shape. An LED color display 142, a Bluetooth transceiver 144, a power source 146, a CPU 148, a DAC 150, a diffuse sensor 154, LEDs 152, a calibration sensor 156, a pocket 158, a tube 160, and lenses 162 and 164 as previously described and illustrated with reference to FIG. 3 are all contained within housing 230.

Color measurement device 102d also includes a power and/or data port 236 and a diagnostic port 240. Power and/or data port 236 is configured for receiving a power and/or data cable 238. In one embodiment, power and/or data port 236 is a USB port. Power and/or data port 236 is used for powering color measurement device 102d and/or for recharging a battery within housing 230. Power and/or data port 236 is also used for passing data, such as configuration data, color data, or other suitable data, between color measurement device 102d and another device. Diagnostic port 240 is configured for receiving a diagnostic cable 242. In one embodiment, diagnostic port 240 is used for receiving an external trigger pulse or strobe for initiating the color sensing of a sample. In one embodiment, diagnostic port 240 is excluded.

Embodiments provide a low cost, compact, easily manipulated, wireless color measurement device for use in a wide variety of applications. Embodiments of the color measurement device include a built in power source, processor, wireless interface, color sensor, and color display.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A device comprising:
a housing;
a color sensor within a first end of the housing, the color sensor configured to sense a color of a sample when the color sensor is placed proximate the sample; and
a display within the housing, the display configured to display the color of the sample sensed by the color sensor.

2. The device of claim 1, further comprising:
a power source within the housing, the power source configured to provide power to the color sensor and to the display.

3. The device of claim 1, further comprising:
a processor within the housing, the processor configured to control the color sensor and the display.

4. The device of claim 1, further comprising:
an interface within the housing, the interface configured for communicating with another device.

5. The device of claim 4, wherein the interface comprises a wireless interface configured for wirelessly communicating with another device.

6. The device of claim 5, wherein the wireless interface comprises a Bluetooth transceiver.

7. The device of claim 1, further comprising:
a trigger configured to activate the color sensor when the trigger is activated.

8. The device of claim 7, wherein the trigger comprises one of a push button, an externally provided pulse, a force feedback tip, a voice command, and a slide switch.

9. The device of claim 1, wherein the color sensor comprises a plurality of LEDs at different wavelengths and a diffuse sensor for sensing the color of the sample.

10. The device of claim 1, wherein the display is within a second end of the housing opposite the first end.

11. The device of claim 1, wherein the display comprises an LED display.

12. The device of claim 1, wherein the color sensor comprises a self calibrating color sensor.

13. The device of claim 1, wherein the color sensor comprises a height/distance detecting ability.

14. A color measurement device comprising:
an elongated cylindrically-shaped housing;
a color sensor within a first end of the housing, the color sensor configured to sense a color of a sample;
a color LED display within a second end of the housing opposite the first end, the color LED display configured to indicate the color of the sample sensed by the color sensor;
a Bluetooth transceiver within the housing, the Bluetooth transceiver configured to communicate the color sensed by the color sensor to another device;
a processor within the housing, the processor configured to control the color sensor, the color LED display, and the Bluetooth transceiver; and
a power source within the housing, the power source configured to provide power to the color sensor, the color LED display, the Bluetooth transceiver, and the processor.

15. The device of claim 14, further comprising:
a force feedback tip at the first end of the housing, the force feedback tip configured to activate the color sensor when the force feedback tip is applied to the sample.

16. A method for measuring color, the method comprising:
positioning a color sensor within a first end of an elongated cylindrically-shaped housing proximate a sample;
sensing a color of the sample with the color sensor; and
indicating the color of the sample on an LED display within the housing.

17. The method of claim 16, further comprising:
wirelessly transmitting the color of the sample to another device with a wireless interface within the housing.

18. The method of claim 17, wherein wirelessly transmitting the color of the sample comprises wirelessly transmitting the color of the sample via a Bluetooth transceiver.

19. The method of claim 16, further comprising:
activating the color sensor when a force feedback tip at the first end of the housing contacts the sample.

20. The method of claim 16, wherein sensing the color of the sample comprises sensing the color of the sample using a plurality of LEDs at different wavelengths and a diffuse sensor.
